(19) United States
(12) Patent Application Publication
(10) Pub. No.: US 2010/0294819 A1
(43) Pub. Date: Nov. 25, 2010

(54) Trailer hitch accessory mounting receiver

(76) Inventor: MICHAEL SPERA, GOLDEN, CO (US)

Correspondence Address: SCOTT L. TERRELL, P.C., STE. E, 12970 W. 20TH AVE, GOLDEN, CO, 80401, US

(21) Appl. No.: 12/454,460

(22) Filed: May 19, 2009

(51) Int. Cl. B60R 9/06; B60R 11/00

(52) U.S. Cl. 224/519

(57) ABSTRACT

An accessory mounting receiver for trailer hitches is provided which includes a trailer hitch insert tube having lateral side walls. The side walls include cooperating aligned apertures for pinned connection to a trailer hitch receiver. An accessory mounting bar has proximal and a distal ends. An accessory receiver box is connected to the distal end of the mounting bar. The accessory receiver box has four side walls. At least two of the side walls each have cooperating diametrically opposed apertures for pinned connection to an accessory insert tube. A collar plate is connected to the proximal end of the mounting bar. The plate is slidably clearance fit for horizontal and vertical rotation of the accessory receiver about the trailer hitch insert tube.

### CROSS REFERENCE TO RELATED APPLICATIONS

None.

### BACKGROUND OF THE INVENTION

1. Field of the Invention

The present invention relates to trailer hitch accessory mounting assemblies. In particular, it relates to a trailer hitch accessory mounting receiver for attaching an accessory to a trailer hitch in horizontal or vertical alignment while pulling a trailer.

2. Description of the Related Art

Conventional trailer hitch mounting assemblies are well known in the art. These assemblies have evolved along a common conception in the design of mounting accessories to a trailer hitch.

One such example, U.S. Pat. No. 5,4223,566 to Warrington et al., discloses a wedge-shaped section located near the top, near portion of a trailer hitch insert tube. The wedge-shaped segment is located opposite a complementary shaped section of the insert tube. The wedge-shaped section engages the insert tube to reduce or eliminate movement of a trailer hitch insert tube within a trailer hitch tube attached to a vehicle.

Another example, U.S. Pat. No. 6,623,025 B2 to McCoy et al., discloses a trailer hitch receiver. This receiver includes an insert tube and a hitch ball carried on the insert tube. The hitch ball includes a ball head, a stem, and a fastener for engaging the stem and securing the hitch ball to the insert tube. The trailer hitch accessory also includes a trailer hitch accessory mounting receiver. The mounting system in configured to include a u-shaped bracket. The bracket includes a first aperture for receiving the shank of the hitch ball and two depending mounting flanges. Each of the mounting flanges includes a second aperture and a third aperture. In addition, the trailer hitch receiver includes a trailer hitch accessory having a trailer hitch accessory mounting bracket coupler. The coupler nests over the bracket. A pivot pin and a separate locking pin are each received in cooperating apertures in the coupler and bracket to complete the connection. In operation, the trailer hitch accessory coupler can be rotated downwardly, in order to expose to hitch ball, in order to alleviate burdensome back and forth swapping of the insert tube and accessory mounting bar when using the hitch ball for pulling a trailer.

While the foregoing examples offer some utility, a major disadvantage in each lies in the fact that, while they do provide for mounting an accessory to a trailer hitch, they do not allow for the attachment of the accessory to the trailer hitch while pulling a trailer coupled to a motor vehicle with a trailer hitch insert tube and ball. Another disadvantage with each example is that they are limited in use to vertically extending accessory mounting bars. Thus, it is desirable to provide a trailer hitch accessory mounting receiver which is designed for use while pulling a trailer. It is also desirable to provide a trailer hitch accessory mounting receiver which is useful with accessory mounting bars coupled in either an horizontal or vertical alignment relative to the vehicle. The present invention satisfies these needs.

### BRIEF SUMMARY OF THE INVENTION

It is therefore an object of the present invention to provide a trailer hitch accessory mounting receiver which is designed for use while pulling a trailer.

It is another object of the present invention to provide a trailer hitch accessory mounting receiver which is useful in coupling an accessory mounting bar in either a horizontal or vertical alignment relative to the vehicle.

It is yet another object of the present invention to provide a one piece trailer hitch accessory mounting receiver which is durable and simple in construction.

To overcome the problems of the prior art methods and in accordance with the purpose of the invention, as embodied and broadly described herein, briefly an accessory mounting receiver is provided which includes a trailer hitch insert tube having lateral side walls, the side walls including cooperating aligned apertures for pinned connection to a trailer hitch receiver, an accessory mounting bar having a proximal and a distal ends, an accessory receiver box connected to the distal end of the mounting bar having four side walls, at least two of the side walls each having cooperating diametrically opposed apertures for pinned connection to an accessory insert tube, and a collar plate connected to the proximal end of the mounting bar, the plate slidably clearance fit for horizontal and vertical rotation of the accessory receiver about the trailer hitch insert tube.

Additional advantages of the present invention will be set forth in part in the description that follows and in part will be obvious from that description or can be learned from practice of the invention. The advantages of the invention can be realized and obtained by the apparatus particularly pointed out in the appended claims.

### BRIEF DESCRIPTION OF THE DRAWINGS

The accompanying drawings, which are incorporated in and of which constitute a part of the specification, illustrate at least one embodiment of the invention and, together with the description, explain the principles of the invention.

FIG. 1 is a rear view of the accessory mounting receiver showing the accessory receiver box connected in a transverse relationship to the mounting bar.

FIG. 2 is a top view of the accessory mounting receiver showing the accessory receiver box connected in a transverse relationship to the mounting bar.

FIG. 3 is a side view from the accessory mounting receiver from the collar plate and extending to the accessory receiver box and showing the receiver box connected in a transverse relationship to the mounting bar.

FIG. 4 is a perspective view of the accessory mounting receiver showing the mounting bar rotated in horizontal alignment for attaching a horizontally extending hitch step accessory together with the ball hitch for coupling to a trailer.

FIG. 5 is a perspective view of the accessory mounting receiver showing the accessory mounting bar rotated in vertical alignment for attaching a vertically extending accessory support bar together with a ball hitch for coupling to a trailer.

FIG. 6 is a perspective view of the accessory mounting receiver showing the mounting bar rotated in vertical alignment for attaching a vertically extending accessory support bar and bike rack together with a ball hitch to for coupling to a trailer.

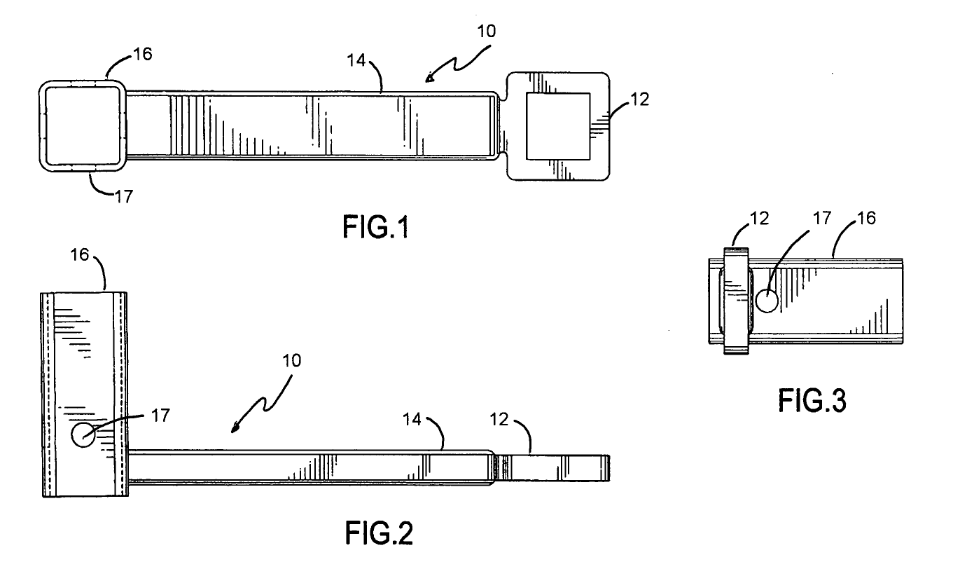

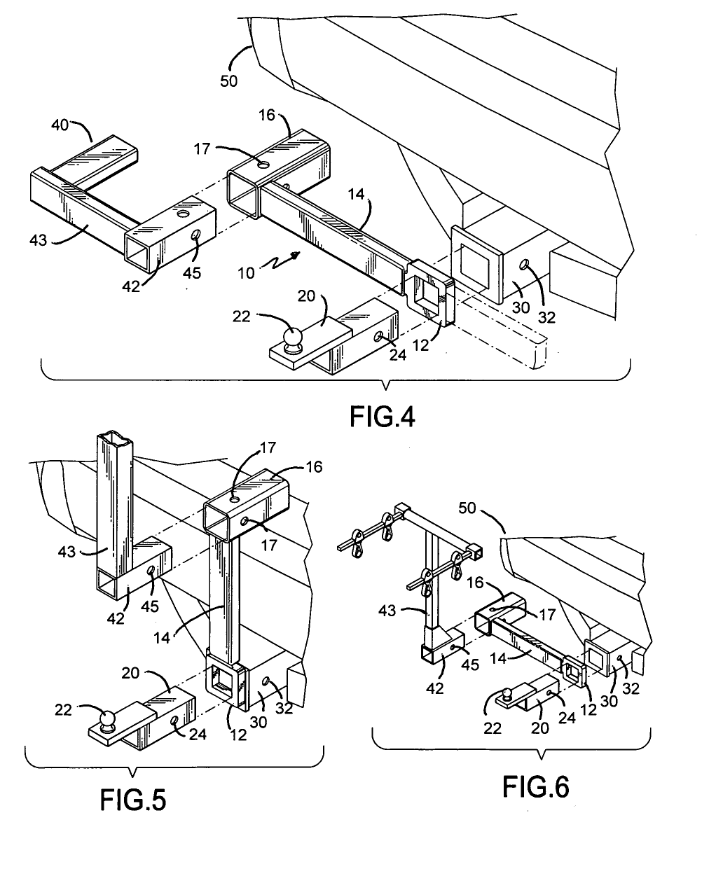

### DETAILED DESCRIPTION OF THE INVENTION

Unless specifically defined otherwise, all technical or scientific terms used herein have the same meaning as commonly understood by one of ordinary skill in the art to which this invention belongs.

Although any of the methods and materials similar or equivalent to those described herein can be used in the practice or testing of the present invention, the preferred methods and materials are now described. Reference will now be made in detail to the presently preferred embodiments of the invention, examples of which are illustrated in the accompanying drawings wherein like numerals represent like features of the invention.

Referring now to the drawing figures, an accessory mounting receiver 10 for trailer hitches is provided. The accessory mounting receiver 10 includes an assembly of the accessory mounting receiver 10 coupled to a trailer hitch insert tube 20. The accessory mounting receiver 10 has middle portion 14 connecting two end portions. At a proximal end portion is a collar plate 12. In use, the collar plate 12 is slidably clearance fit about the trailer hitch insert tube 20. At the distal end of the middle portion 14 is an accessory receiver tube 16.

The middle portion 14 of the accessory mounting receiver 10 and the accessory insert tube 16 are preferably square tube sections, and are desirably constructed from heavy gauge steel or cast iron. The end of the trailer hitch insert tube 20 is coupled to a trailer hitch receiver box 30 of a trailer hitch receiver carried on a towing vehicle 50. The trailer hitch insert tube 20 includes diametrically aligned apertures 24 in the side-walls for receiving a connecting pin. The connecting pin is inserted through apertures 32 in the trailer hitch receiver 30 and cooperating aligned apertures 24 in the side-walls of the trailer hitch insert tube 20 to complete the connection of the trailer hitch insert tube 20 to the trailer hitch receiver box 30. The head end of the trailer hitch insert tube 20 desirably includes an aperture that receives a threaded stem of a hitch ball 22, of a type which is well known in the art.

At the proximal end of the accessory mounting receiver 10 is a square collar plate 12. The collar plate 12 is preferably cut of heavy gauge steel, aluminum, or is formed with cast iron. In use, the collar plate 12 is slidably clearance fit over the trailer hitch insert tube 20 prior to, or during, insertion of the trailer hitch insert tube 20 into the trailer hitch receiver 30. Tolerance of the clearance fit is not critical. However, it is desirable to construct the clearance fit so as to allow the collar plate 12 to slide easily over the trailer hitch insert tube 20 and, at the same time, keep the accessory receiver 10 rigidly attached to the trailer hitch receiver tube 20 while traveling. It can be appreciated that the collar plate 12 may be constructed of any dimension corresponding to the dimensions of the trailer hitch insert tube 20. The collar plate 12 is welded in construction to the middle portion 14 of the accessory mounting receiver 16. When using a square tube construction for the middle portion 14, the collar plate 12 may, but need not, include a box end at one side wall to be slidably fit and welded into an end of the square tube. Because the collar plate 12 is clearance fit over the trailer hitch insert tube 20, the collar plate 12 may be installed in either a horizontal or vertical relationship to the vehicle 50 depending on the desired direction of an accessory mounting bar 43, to be attached.

The middle portion 14 of the accessory mounting receiver 10 is desirably constructed of heavy gauge steel tubing and operates as a lever arm to support the accessory receiver box 16. It can be appreciated that the middle portion 14 of the accessory mounting receiver 10 may be constructed in a variety of different lengths for use in relation to the height or width of any motor vehicle 50. For example, it is contemplated that a shorter length would be desirable for use with a compact car and a longer length would be useful for attachment to a full sized truck or sport utility vehicle.

At the distal end of the middle portion 14 is the accessory receiver box 16. The accessory receiver box 16 is also constructed of heavy gauge steel tubing but may be constructed of cast iron or the equivalent in strength and rigidity. As shown in the drawing figures, the accessory receiver box 16 is connected to the middle portion 14 in a transverse relationship such that the receiver box 16 extends outwardly from the rear of the motor vehicle 50. In this manner, the accessory receiver box 16 is connected to accept an accessory 40 having a substantially L-shaped supporting bar 43 and accessory insert tube 42. Although not shown in the drawing figures, but specifically contemplated as another embodiment of the present invention, is a construction of the accessory mounting receiver 10 wherein a bottom portion of the accessory receiver box 16 is connected in axial alignment with the middle portion 14 of the accessory mounting receiver 10. In this manner, the accessory receiver box 16 fits an accessory supporting bar 43 with an accessory insert tube 42 positioned in axial alignment with an accessory supporting bar 43, as opposed to one with the typical L-shaped configuration, as illustrated in the drawing figures. The accessory receiver box 16 desirably includes four apertures 17, one in each of the side walls, for cooperative alignment with apertures 45 in the accessory insert tube 42. In providing four apertures 17, the accessory mounting receiver 10, in accordance with the present invention, allows for coupling to a wide range of accessories 40 because the accessory mounting receiver 10 may be interchangeably fit in either a vertical of horizontal alignment. As with the collar plate 12, the accessory receiver box 16 may be connected to the middle portion 14 using a rivet, bolt or weld. The entire accessory mounting receiver 10; that is the receiver box 16, middle portion 14, and collar 12, may also be constructed as a single member.

Referring now to FIG. 5, by way of example, the illustrated accessory 40 is a step which travels under a rear fender well of the motor vehicle 50 when coupled to the accessory mounting receiver 10 fit to the trailer hitch insert tube 20 in a horizontal direction. Of course, in use, with the hitch step accessory 40 as an example, the hitch step 40 is easily rotated 180 degrees in order to rest either under the left or right fender well by simply removing the trailer hitch insert tube 20, rotating the accessory mounting receiver 10 180 degrees, and reattaching the trailer hitch insert tube 20 through the collar plate 12.

Referring now to FIG. 6, as yet another example, the accessory is a sport rack, such as one which may be used to transport a bicycle. Here, the accessory mounting receiver 10 is easily rotated to a vertical plane for upright attachment of an insert tube 42 of the rack accessory. If the rack accessory were so constructed as to have an accessory insert tube 42, or the support bar 43 itself, constructed in axial alignment with the accessory support bar 43, as opposed to an L-shaped support post 43 and accessory insert tube 42 configuration, the second embodiment of the present invention would be useful whereby the accessory mounting receiver box 16 is connected in axial alignment to the middle portion 14 in attaching the accessory. It should be appreciated, however, that many other types of article carriers could be utilized which include, but are not limited to, cargo boxes, ski carriers, snow board carriers, transportable tables, benches and/or barbecues. In addition, it can also be appreciated that two or more accessory mounting receivers 10, provided in accordance with the present invention, may be attached in tandem, depending on the length of the trailer hitch insert tube 20, and could be used to support two or more accessories, such as a rack, as shown in FIG. 6, and a hitch step 40.

While the present invention has been described in connection with the embodiments as described and illustrated above, it will be appreciated and understood by one of ordinary skill in the art that modifications may be made in the accessory mounting receiver, in accordance with the present invention, without departing from the true spirit and scope of the invention as described and claimed herein.

I claim:

1. An accessory mounting receiver, comprising:
(a) a trailer hitch insert tube having lateral side walls, the side walls including cooperating aligned apertures for pinned connection to a trailer hitch receiver;
(b) an accessory mounting bar having a proximal and a distal ends;
(c) an accessory receiver box connected to the distal end of the mounting bar having four side walls, at least two of the side walls each having cooperating diametrically opposed apertures for pinned connection to an accessory insert tube; and
(d) a collar plate connected to the proximal end of the mounting bar, the plate slidably clearance fit for horizontal and vertical rotation of the accessory receiver about the trailer hitch insert tube.

2. The accessory mounting receiver according to claim 1, wherein the accessory receiver box is connected on at least one side wall in transverse alignment with the mounting bar.

3. The accessory mounting receiver according to claim 1, wherein the accessory receiver box is connected in axial alignment with the mounting bar.

4. The accessory mounting receiver according to claim 1, further comprising a hitch ball connected to the trailer hitch insert tube.

5. The accessory mounting receiver according to claim 1, wherein the accessory is a step or a rack.

6. The accessory mounting receiver according to claim 1, wherein the four sidewalls of the accessory receiver box each have cooperating diametrically opposed apertures for pinned connection to an accessory insert tube.
